(19) United States
(12) Patent Application Publication
(10) Pub. No.: US 2014/0097356 A1
(43) Pub. Date: Apr. 10, 2014

(54) DISPLAY DEVICE

(71) Applicant: Electronics and Telecommunications Research Institute, (US)

(72) Inventors: Bong Je PARK, Daejeon (KR); Suntak PARK, Daejeon (KR)

(73) Assignee: Electronics and Telecommunications Research Institute, Daejeon (KR)

(21) Appl. No.: 13/794,646

(22) Filed: Mar. 11, 2013

(30) Foreign Application Priority Data
Oct. 4, 2012 (KR) 10-2012-0110153
Oct. 4, 2012 (KR) 10-2012-0110158

(51) Int. Cl. F21V 8/00

(52) U.S. Cl. CPC G02B 6/0066
USPC 250/458.1

(57) ABSTRACT

A display device is provided. The display device may include an infrared light source; and a light guide pad which is disposed to be adjacent to the infrared light source and includes fluorescent patterns including fluorescent bodies of nano size excited by invisible light irradiated from the infrared light source to emit visible light.

### CROSS-REFERENCE TO RELATED APPLICATIONS

This U.S. non-provisional patent application claims priority under 35 U.S.C. § 119 of Korean Patent Application No. 10-2012-0110158, filed on Oct. 4, 2012, and Korean Patent Application No. 10-2012-0110153, filed on Oct. 4, 2012, the entire contents of which are hereby incorporated by reference.

### BACKGROUND

The present inventive concept herein relates to display devices, and more particularly, to a display device by excitation of fluorescent patterns.

A typical field of a future flat display is a flexible display field and a transparent display field. In case of the transparent display, a method of realizing the transparent display by projecting a wanted information display onto a transparent screen using a transparent thing as a background of a screen and a method of realizing the transparent display directly using a transparent screen are being developed. In case of the method of realizing a transparent display by projecting a wanted display onto a transparent screen, it is being developed into a head up display (HUD) and a head mounted display (HMD) and in case of the method of realizing the transparent display directly using a transparent screen, it is being developed into a thin film electroluminescence (TFEL), an organic light emitting diode (OLED) and a transparent LCD.

An up-conversion phenomenon is a phenomenon of absorbing two or more low energy light quanta to emit a high energy light quantum and a fluorescent body using the up-conversion phenomenon is called an up-conversion fluorescent body. Thus, in case of irradiating an infrared light source having low energy into an up-conversion fluorescent body, a display device is realized by emitting visible light having high energy. A prior art related to a display device using the up-conversion fluorescent body can be classified into a powder fluorescent body and a nano fluorescent body according to a used material, and a technology using a polymer up-conversion material is invented these days. In case of using a powder fluorescent body, it is difficult to realize a transparent display. However, in case of using a nano fluorescent body and a polymer up-conversion material, it is possible to realize a transparent display. Depending on a structure of display device, there are a method of displaying information on a transparent display in which an up-conversion fluorescent body is included using a laser scanner and a method of displaying information by forming an up-conversion fluorescent pixel in a semiconductor laser. A technology related to a 3D display device using infrared light sources of different wavelengths is invented.

From the viewpoint of a display structure, in case of the method of displaying information on a transparent display in which an up-conversion fluorescent body is included using a laser scanner, there is a disadvantage of installing a laser scanner outside the transparent display. In this case, since a laser scanner has to be installed outside the transparent display, if things exist between the scanner equipment and the transparent display, information to be displayed cannot be displayed and since an infrared light source is away from the screen, a higher efficient infrared light source is needed. Also, since an additional scanner equipment is installed, it is difficult to integrate the display device and the price of display device increases. In case of the method of displaying information by forming an up-conversion fluorescent pixel in a semiconductor laser, since the semiconductor laser is not transparent, it is difficult to manufacture a transparent display device.

From the viewpoint of a fluorescent body being used, since it is impossible to realize a transparent display in case of using an up-conversion fluorescent body of powder form, use of up-conversion fluorescent body of powder form is impossible to realize a complete transparent display.

### SUMMARY

Embodiments of the inventive concept provide a display device. The display device may include an infrared light source; and a light guide pad which is adjacent to the infrared light source and includes fluorescent patterns excited by invisible light irradiated from the infrared light source to emit visible light.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIGS. 1A and 1B are a perspective view and a cross sectional view for explaining a display device in accordance with some embodiments of the inventive concept.

FIGS. 2A and 2B are a perspective view and a cross sectional view for explaining a display device in accordance with further embodiments of the inventive concept.

FIGS. 3A and 3B are a perspective view and a cross sectional view for explaining a display device in accordance with still further embodiments of the inventive concept.

FIGS. 4A and 4B are a perspective view and a cross sectional view for explaining a display device in accordance with yet further embodiments of the inventive concept.

FIG. 5 is a flow chart for explaining a method of manufacturing a display device in accordance with some embodiments of the inventive concept.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element such as a layer, region or substrate is referred to as being “on” or “onto” another element, it may lie directly on the other element or intervening elements or layers may also be present.

Embodiments of the inventive concept may be described with reference to cross-sectional illustrations, which are schematic illustrations of idealized embodiments of the present invention. As such, variations from the shapes of the illustrations, as a result, for example, of manufacturing techniques and/or tolerances, are to be expected. Thus, embodiments of the present invention should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of the present invention.

It will be understood that, although the terms first, second, etc. may be used herein to describe various elements, these elements should not be limited by these terms. These terms are only used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

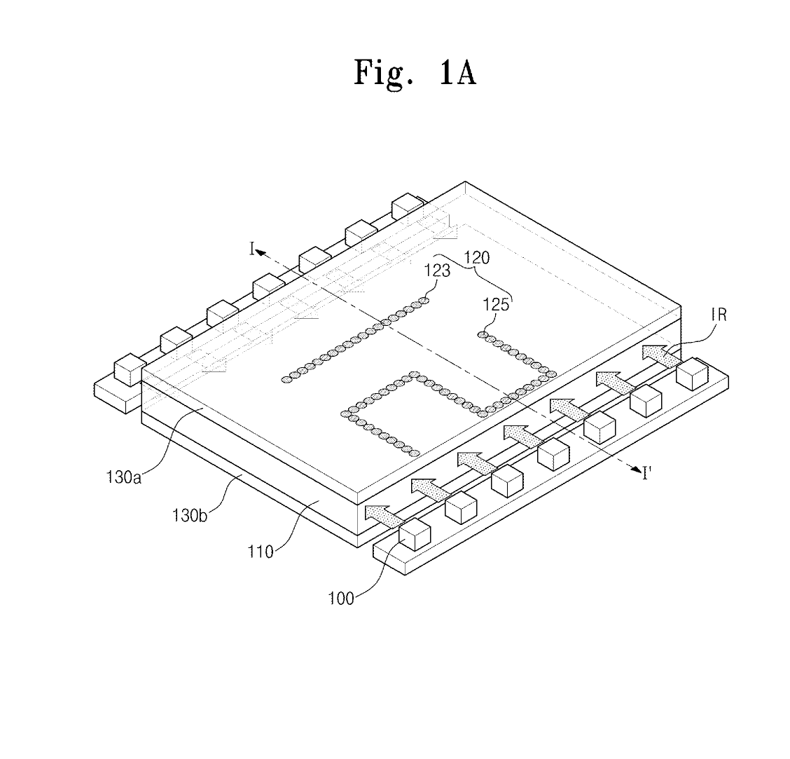

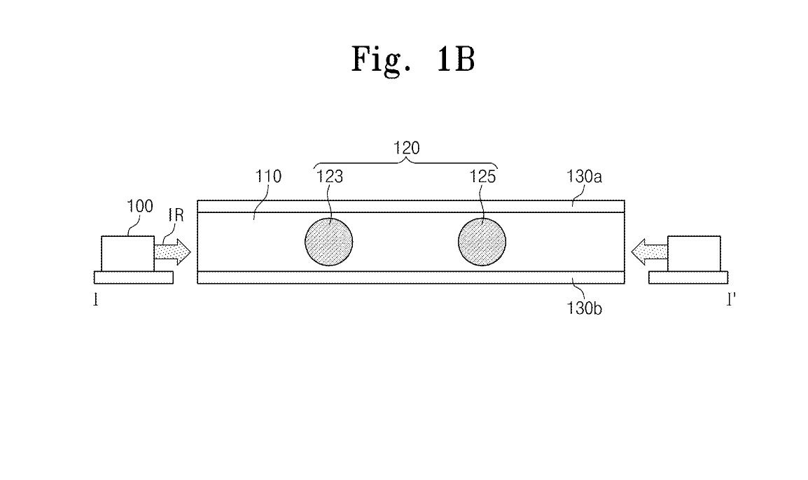

FIGS. 1A and 1B are a perspective view and a cross sectional view for explaining a display device in accordance with some embodiments of the inventive concept. FIG. 1B is a cross sectional view taken along the line I-I′ of FIG. 1A.

Referring to FIGS. 1A and 1B, the display device may include an infrared light source 100 and a light guide pad 110.

The infrared light source 100 may include a light emitting diode (LED) or a laser diode (LD) irradiating infrared ray IR. According to some embodiments of the inventive concept, the infrared light source 100 may be disposed at the side of the light guide pad 110.

The light guide pad 110 has superior light penetrability and may be formed of a transparent material. For instance, the light guide pad 110 may include acrylic material.

Florescent patterns 120 may be disposed in the light guide pad 110. The fluorescent patterns 120 may be arranged in the forms of number, character and logo. The fluorescent patterns 120 may include up-conversion fluorescent bodies which are excited by infrared ray IR irradiated from the infrared light source 100 to emit visible light. When the fluorescent patterns 120 emit visible light in response to the infrared ray IR, a physical phenomenon called an up-conversion occurs. The infrared ray IR has a longer wavelength and a lower energy than visible light. Thus, when fluorescent patterns 120 absorb infrared ray IR to emit visible light, since an energy level of the infrared ray IR increases, the infrared ray IR is up-converted into visible light. In a physical phenomenon of the up-conversion, the emission of visible light quantum needs to absorb at least one infrared light quantum.

The fluorescent patterns 120 may include a plurality of fluorescent bodies 123 and 125 and each of the plurality of fluorescent bodies 123 and 125 may have a nano size. For instance, each of the plurality of fluorescent bodies 123 and 125 may have a size of about 1 nm to about 100 nm. Since each of the plurality of fluorescent bodies 123 and 125 has a nano size, when an infrared ray IR is not irradiated, the fluorescent patterns 120 formed in the light guide pad 110 may be in a transparent state. Thus, a complete transparent display device can be realized.

The fluorescent patterns 120 may include first fluorescent bodies 123 emitting a first visible color and second fluorescent bodies 125 emitting a second visible color different from the first visible color. The first and second fluorescent bodies 123 and 125 may be arranged while making a group.

The first and second fluorescent bodies 123 and 125 may include rare-earth elements. For instance, the first and second fluorescent bodies 123 and 125 may include at least one selected from the group consisting of terbium Tb, europium Eu, ytterbium Yb, thulium Tm, erbium Er, praseodymium Pr and cerium Ce. The rare-earth elements of the first and second fluorescent bodies 123 and 125 may be in a state that they are mixed with organic-binder.

In the present embodiment, the fluorescent patterns 120 emit two visible colors. However, the quantity of visible colors is not limited thereto.

The display device may further include protection films 130a and 130b for protecting the display device. The protection films 130a and 130b may be disposed a top surface and a bottom surface of the light guide pad 110 in which the fluorescent patterns 120 are disposed respectively. The protection films 130a and 130b may be formed of flexible material. Thus, the display device may be curved or rolled up and thereby more flexible display device can be provided.

Since the fluorescent bodies 123 and 125 of the fluorescent patterns 120 have a nano size, when an infrared ray IR is not irradiated from the infrared light source 100, a display device of complete transparent state can be provided. Since invisible light such as infrared ray IR is irradiated into the light guide pad 110 and the fluorescent patterns 120 in the light guide pad 110 convert the infrared ray IR into visible light to emit the visible light, only wanted advertising slogan can be more effectively and visually displayed.

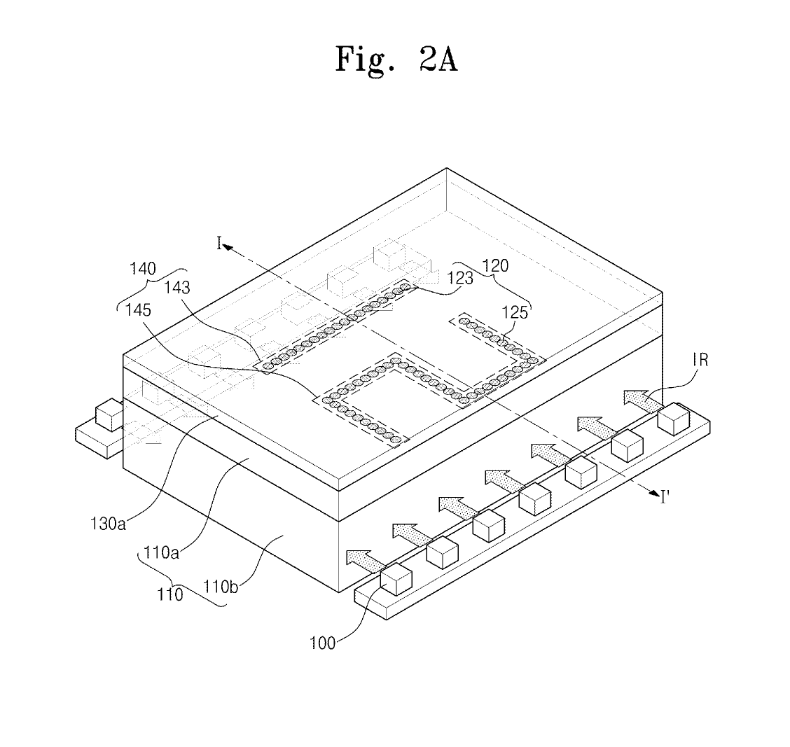

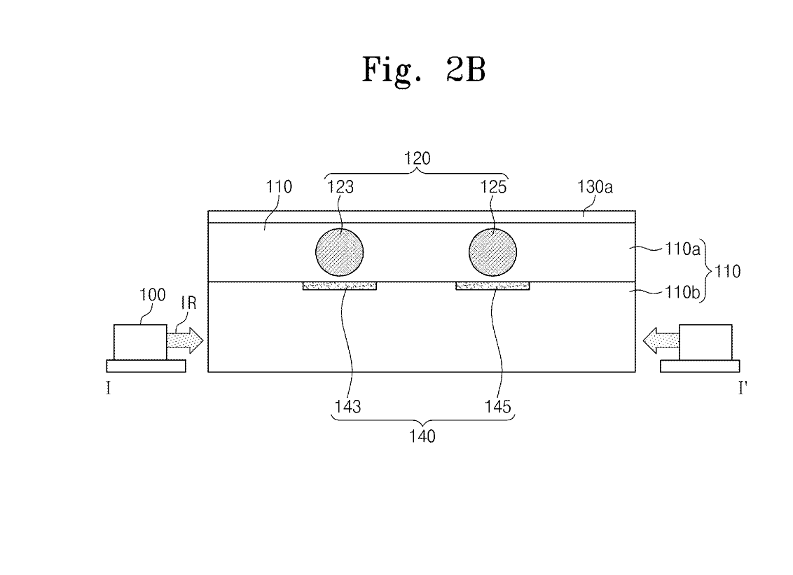

FIGS. 2A and 2B are a perspective view and a cross sectional view for explaining a display device in accordance with further embodiments of the inventive concept. FIG. 2B is a cross sectional view taken along the line I-I′ of FIG. 2A.

Referring to FIGS. 2A and 2B, the display device may include an infrared light source 100, scattering patterns 140 and a light guide pad 110.

The light guide pad 110 may include an upper light guide layer 110a and a lower light guide layer 110b. Fluorescent patterns 120 may be disposed in the upper light guide layer 110a.

The scattering patterns 140 may be disposed at positions corresponding to the fluorescent patterns 120. The fluorescent patterns 120 may include first fluorescent body 123 emitting a first visible color and second fluorescent body 125 emitting a second visible color different from the first visible color. The first fluorescent body 123 may be disposed at a first area of the upper light guide layer 110a and the second fluorescent body 125 may be disposed at a second area of the upper light guide layer 110a. The scattering patterns 140 may include a first scattering pattern 143 and a second scattering pattern 145 disposed at positions corresponding to the first area and the second area in the upper light guide layer 110a respectively.

The infrared light source 100 may be disposed at the side of the lower light guide layer 110b. The scattering patterns 140 change a progressing direction of infrared ray IR irradiated from the infrared light source 100 to make the infrared ray

IR more effectively reach the fluorescent patterns 120.

The display device may further include a protection film 130a disposed at a top surface of the upper light guide layer 110a to protect the display device.

Omitted descriptions of the infrared light source 100, the light guide pad 110 and the fluorescent patterns 120 illustrated in FIGS. 2A and 2B may be substantially the same as those of the infrared light source 100, the light guide pad 110 and the fluorescent patterns 120 described in FIGS. 1A and 1B.

Since the fluorescent bodies 123 and 125 of the fluorescent patterns 120 have a nano size, when an infrared ray IR is not irradiated from the infrared light source 100, a display device of complete transparent state can be provided. Since invisible light such as infrared ray IR is irradiated into the light guide pad 110 and the fluorescent patterns 120 in the light guide pad 110 convert the infrared ray IR into visible light to emit the visible light, only wanted advertising slogan can be more effectively and visually displayed. The display device further includes the scattering patterns 140 and thereby the infrared ray IR can more effectively reach the fluorescent patterns 120.

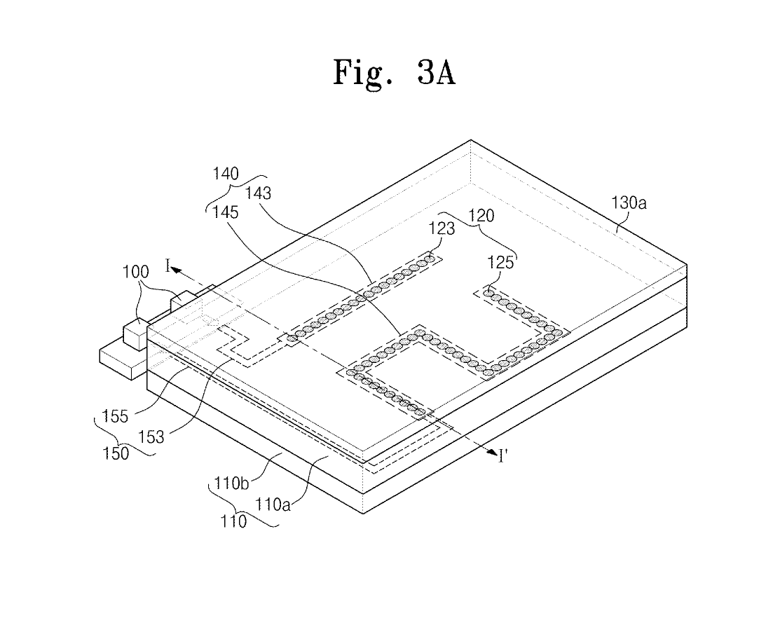

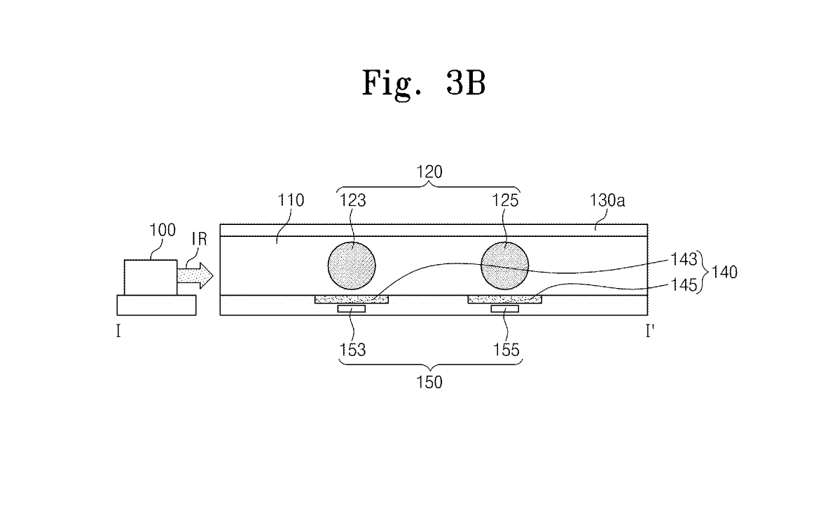

FIGS. 3A and 3B are a perspective view and a cross sectional view for explaining a display device in accordance with still further embodiments of the inventive concept. FIG. 3B is a cross sectional view taken along the line I-I′ of FIG. 3A.

Referring to FIGS. 3A and 3B, the display device may include an infrared light source 100, scattering patterns 140, a light guide pad 110 and optical waveguides 150.

The light guide pad 110 may include an upper light guide layer 110a in which the fluorescent patterns 120 are formed and a lower light guide layer 110b in which the scattering patterns 140 are formed.

The infrared light source 100 may include a laser diode Infrared ray IR irradiated from the laser diode may have directivity. The optical waveguides 150 may be used so that the infrared ray IR irradiated from the laser diode reaches the aimed fluorescent patterns 120.

The optical waveguides 150 are disposed in the lower light guide layer 110b and may be disposed to be adjacent to the scattering patterns 140. The optical waveguides 150 may have the quantity corresponding to the quantity of the infrared light sources 100. For instance, the optical waveguides 150 may include a first optical waveguide 153 connecting one of the infrared light sources 100 and the first scattering pattern 143 and a second optical waveguide 155 connecting the other of the infrared light sources 100 and the second scattering pattern 145.

In the present embodiment, two optical waveguides 150 are illustrated.

However, the quantity of the optical waveguides 150 is not limited thereto.

The display device may further include a protection film 130a disposed at a top surface of the upper light guide layer 110a to protect the display device.

Omitted descriptions of the infrared light source 100, the light guide pad 110 and the fluorescent patterns 120 illustrated in FIGS. 3A and 3B may be substantially the same as those of the infrared light source 100, the light guide pad 110 and the fluorescent patterns 120 described in FIGS. 1A, 1B, 2A and 2B.

Since the fluorescent bodies 123 and 125 of the fluorescent patterns 120 have a nano size, when an infrared ray IR is not irradiated from the infrared light source 100, a display device of complete transparent state can be provided. Since invisible light such as infrared ray IR is irradiated into the light guide pad 110 and the fluorescent patterns 120 in the light guide pad 110 convert the infrared ray IR into visible light to emit the visible light, only wanted advertising slogan can be more effectively and visually displayed. By using a laser diode as the infrared light source 100, a size of the display device can be reduced and power consumption can be reduced.

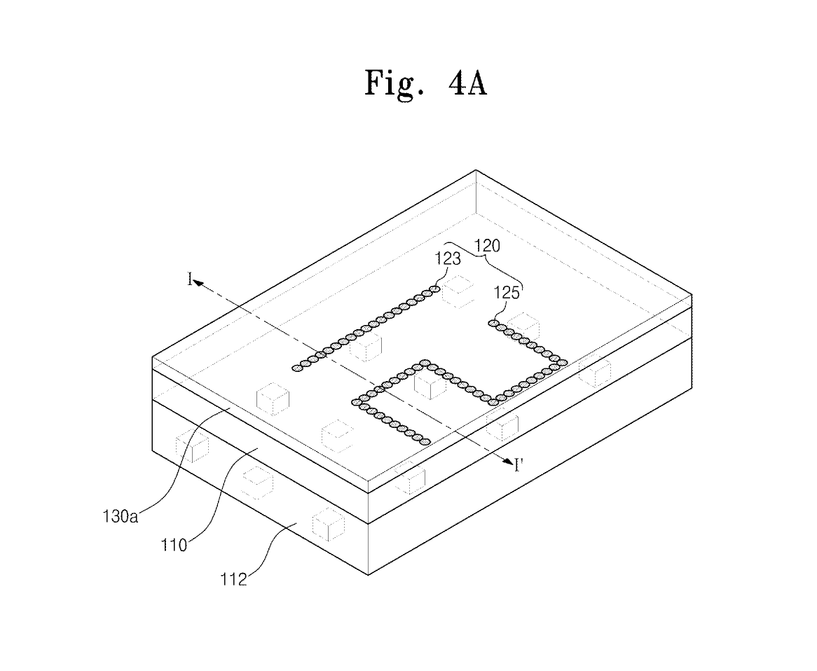

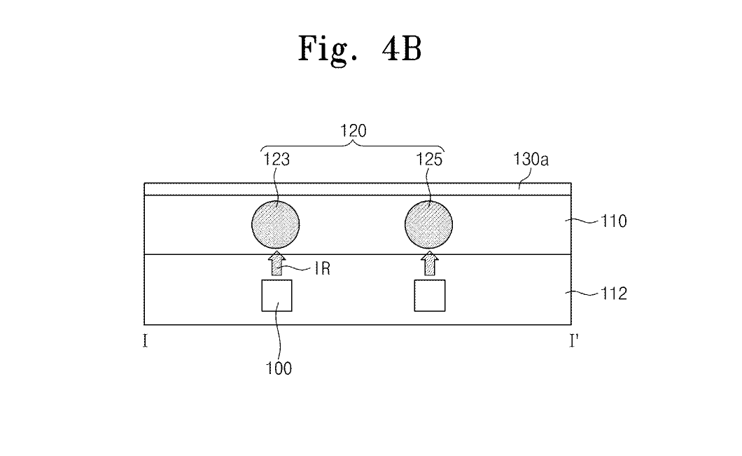

FIGS. 4A and 4B are a perspective view and a cross sectional view for explaining a display device in accordance with yet further embodiments of the inventive concept. FIG. 4B is a cross sectional view taken along the line I-I′ of FIG. 4A.

Referring to FIGS. 4A and 4B, the display device may include an infrared light source 100 and a light guide pad 110.

The infrared light source 100 may be disposed at a lower side of the light guide pad 110 to irradiate infrared ray IR into fluorescent patterns 120 disposed in the light guide pad 110 in a backlight type. The infrared light source 100 may include a light emitting diode and/or a laser diode. The infrared light source 100 may be disposed in a light source part 112.

The display device may further include a protection film 130a disposed at a top surface of the light guide pad 110 to protect the display device.

Omitted descriptions of the infrared light source 100, the light guide pad 110 and the fluorescent patterns 120 illustrated in FIGS. 4A and 4B may be substantially the same as those of the infrared light source 100, the light guide pad 110 and the fluorescent patterns 120 described in FIGS. 1A and 1B.

Since the fluorescent bodies 123 and 125 of the fluorescent patterns 120 have a nano size, when an infrared ray IR is not irradiated from the infrared light source 100, a display device of complete transparent state can be provided. Since invisible light such as infrared ray IR is irradiated into the light guide pad 110 and the fluorescent patterns 120 in the light guide pad 110 convert the infrared ray IR into visible light to emit the visible light, only wanted advertising slogan can be more effectively and visually displayed.

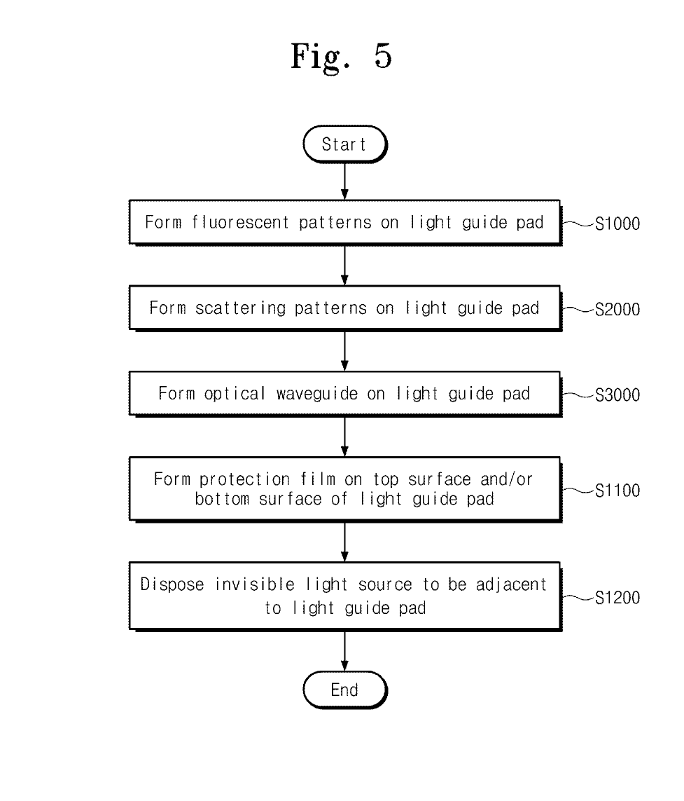

FIG. 5 is a flow chart for explaining a method of manufacturing a display device in accordance with some embodiments of the inventive concept.

Referring to FIG. 5, fluorescent patterns may be formed on a light guide pad (S1000). The fluorescent patterns may be disposed in an aimed arrangement. The fluorescent patterns may be arranged while making a group among fluorescent bodies emitting different colors from each other. A protection film may be formed on a top surface of the light guide pad and/or a bottom surface of the light guide pad (S1100).

An invisible light source may be disposed to be adjacent to the light guide pad (S1200). According to some embodiments illustrated in FIGS. 1A and 1B, the invisible light source may be disposed at the side of the light guide pad. According to yet further embodiments illustrated in FIGS. 4A and 4B, the invisible light source may be disposed at a lower side of the light guide pad.

According to further embodiments illustrated in FIGS. 2A and 2B, fluorescent patterns and scattering patterns may be formed on the light guide pad (S2000). The fluorescent patterns may be formed in an upper light guide layer of the light guide pad and the scattering patterns may be formed in a lower light guide layer of the light guide pad. For instance, when the fluorescent patterns include first fluorescent bodies emitting a first color and second fluorescent bodies emitting a second color, the scattering patterns may be formed to correspond to the first fluorescent bodies and the second fluorescent bodies respectively. The scattering patterns may be formed before the fluorescent patterns are formed.

According to still further embodiments illustrated in FIGS. 3A and 3B, fluorescent patterns, scattering patterns and optical waveguides may be formed in the light guide pad (S3000). The fluorescent patterns are formed in an upper light guide layer of the light guide pad, and the scattering patterns and the optical waveguides may be formed in a lower light guide layer of the light guide pad. The optical waveguides can connect the infrared light sources to the scattering patterns respectively. In this case, the invisible light source includes a laser diode and may be disposed to be the plural number. After forming the optical waveguides and the scattering patterns, the fluorescent patterns can be formed.

According to embodiments of concepts of this invention, since the fluorescent bodies of the fluorescent patterns have a nano size, when an infrared ray is not irradiated from the infrared light source, a display device of complete transparent state can be provided. Additionally, since invisible light such as infrared ray is irradiated into the light guide pad and the fluorescent patterns in the light guide pad convert the infrared ray into visible light to emit the visible light, only wanted advertising slogan can be more effectively and visually displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Therefore, the above-disclosed subject matter is to be considered illustrative, and not restrictive.

What is claimed is:

1. A display device comprising:
an infrared light source; and
a light guide pad including fluorescent patterns excited by invisible light irradiated from the infrared light source to emit visible light, the light guide pad adjacent to the infrared light source.

2. The display device of claim 1, further comprising a protection film which is disposed at a top surface and/or a bottom surface of the light guide pad and protects the fluorescent patterns.

3. The display device of claim 2, wherein the protection film includes a flexible material.

4. The display device of claim 1, wherein the light guide pad includes:
an upper light guide layer in which the fluorescent patterns are disposed; and
a lower light guide layer adjacent to the upper light guide layer.

5. The display device of claim 4, wherein the infrared light source is disposed at the side of the lower light guide layer, further comprising scattering patterns disposed at places corresponding to the fluorescent patterns respectively in the lower light guide layer.

6. The display device of claim 5, wherein the infrared light source includes a laser diode, further comprising an optical waveguide which is disposed in the lower light guide layer and transfers light irradiated from the infrared light source to the scattering patterns respectively.

7. The display device of claim 1, wherein the infrared light source includes a light emitting diode and/or a laser diode.

8. The display device of claim 1, wherein the infrared light source is disposed below a place corresponding to the light guide pad.

9. The display device of claim 1, wherein the fluorescent patterns have fluorescent bodies of nano size.

10. The display device of claim 9, wherein the light guide pad includes a transparent material and wherein if light from the infrared light source is not irradiated into the fluorescent bodies of nano size, the fluorescent patterns are transparent.
